(19) United States
(12) Patent Application Publication
(10) Pub. No.: US 2008/0219394 A1
(43) Pub. Date: Sep. 11, 2008

(54) METHOD AND SYSTEM FOR CALCULATING AN ADJUSTED PEAK NODAL POWER IN A NUCLEAR REACTOR

(76) Inventors: Richard D. McCord, Wilmington, NC (US); James E. Fawks, Wilmington, NC (US); Robert A. Rand, Wilmington, NC (US)

Correspondence Address: HARNESS, DICKEY & PIERCE, P.L.C., P.O. BOX 8910, RESTON, VA, 20195, US

(21) Appl. No.: 11/618,367

(22) Filed: Mar. 8, 2007

(51) Int. Cl. G21C 17/104

(52) U.S. Cl. 376/254

(57) ABSTRACT

Systems and methods for a nuclear reactor that include developing a first peaking factor at a first burnup threshold for one or more fuel rods. A second peaking factor is developed at a second burnup threshold for the fuel rods. The second burnup threshold is greater than the first burnup threshold. A third peaking factor is developed and is associated with a peak average power threshold for the fuel rods. An adjusted peak nodal power is generated for the fuel rods as a function of a base peak nodal power, the first peaking factor, the second peaking factor, and the third peaking factor.

### FIELD

This invention relates generally to nuclear reactors and, more specifically, for calculating an adjusted peak nodal power in a nuclear reactor and utilizing such adjusted peak nodal power in the design and operation of the nuclear reactor.

### BACKGROUND

The statements in this section merely provide background information related to the present disclosure and may not constitute prior art.

Nuclear plants have to conform to regulatory standards and guidelines for evaluating operations and for radiological consequences of design basis accidents. The regulatory guidelines provide guidance to licensees of power reactors on acceptable applications of Alternative Source Terms (AST). AST's include the scope, nature, and documentation of associated analyses and evaluations, consideration of impacts on analyzed risk, and content of submittals. The guidelines establish an acceptable AST and identify the significant attributes of other ASTs that may be found acceptable by the U.S. Nuclear Regulatory Commission (NRC). The guidelines also identify acceptable radiological analysis assumptions for use in conjunction with the accepted AST. The NRC mandates these guidelines in 10 CFR Part 50 documentation, particularly, 10 CFR 50.67 which describes the AST methodology characterized by radionuclide composition and magnitude, chemical and physical form of the nuclides, and the timing of release of these radionuclides. As part of the AST methodology, the inventory of fission products in the reactor core and availability of release to the containment may be determined to be acceptable for use with currently approved fuel. These values are evaluated to determine whether they are consistent with the safety margins, including margins to account for analysis uncertainties. The safety margins are products of specific values and limits contained in the technical specifications (which cannot be changed without NRC approval) and other values, such as assumed accident or transient initial conditions or assumed safety system response times.

As an example, fractions of fission product inventory for fuel with a peak exposure of up to, for example, 62,000 mega watt-days per metric ton of Uranium (MWD/MTU) may be evaluated, if the maximum linear heat generation rate does not exceed six point three (6.3) kilo-watt per feet (kW/ft) peak rod average power for exposures exceeding fifty four thousand MWD/MTU. In other words, the AST methodology basis may simplify the acceptance criterion, (i.e., if the peak rod average exposure exceeds fifty four thousand (54,000) MWD/MTU, then the rod's average linear heat generation rate cannot exceed 6.3 kW/ft).

However, these AST methodologies are not easily adaptable for showing compliance of criteria during the design, optimization, licensing, and/or monitoring phases because current methodologies are not easily adapted to such methodologies. In other words, to obtain the criterion of the fuel rods, the AST guidelines must be adapted to real world design, optimization, licensing, and/or monitoring phases, which have been shown to be very time-consuming and laborious. Conservative assumptions are often employed to determine such criteria, which results in lost plant efficiency. Additionally, current procedures often provide inaccurate criteria that can adversely impact plant operations.

### SUMMARY

The inventors hereof have identified a need to automatically adjust and adapt AST requirements to nuclear reactor objectives. To this end, the inventors hereof have succeeded at designing methods and systems for determining an adjusted peak nodal power for nuclear reactors that is capable of enabling improved design, monitoring, and operation of the nuclear reactor while ensuring compliance with objectives and guidelines. Such improvements, in some embodiments, can provide for improved operations, reduced refueling outages, and/or greater safety margins.

According to one aspect, a method for a nuclear reactor includes developing a first peaking factor at a first burnup threshold for one or more fuel rods. A second peaking factor is developed at a second burnup threshold for the fuel rods. The second burnup threshold is greater than the first burnup threshold. A third peaking factor is developed and is associated with a peak average power threshold for the fuel rods. An adjusted peak nodal power is generated for the fuel rods as a function of a base peak nodal power, the first peaking factor, the second peaking factor, and the third peaking factor.

According to another aspect, a method for a nuclear reactor includes determining a base peak nodal power for one or more fuel rods. The method also includes developing for the fuel rods a first peaking factor at a first burnup threshold, a second peaking factor at a second burnup threshold, and a third peaking factor associated with a peak average power threshold. A first peak nodal burnup threshold is determined by multiplying the first burnup threshold by the first peaking factor, a second peak nodal burnup threshold is determined by multiplying the second burnup threshold by the second peaking factor, and a peak nodal power is determined by multiplying the peak average power threshold by the third peaking factor. An adjusted peak nodal power is generated for the fuel rods in response to the base peak nodal power, the first peak nodal burnup threshold, the peak nodal power and the second peak nodal burnup threshold.

According to yet another aspect, a method for a nuclear reactor includes plotting a base peak nodal power for one or more fuel rods. A first peak nodal burnup threshold is determined by multiplying the first burnup threshold by the first peaking factor, a second peak nodal burnup threshold is determined by multiplying the second burnup threshold by the second peaking factor, and a peak nodal power is determined by multiplying the peak average power threshold by the third peaking factor. A plot of an adjusted peak nodal power is generated from the plot of the base peak nodal power in response to the first peak nodal burnup threshold, the peak nodal power, and the second peak nodal burnup threshold.

According to still another aspect, a method for use in designing a nuclear reactor includes determining a base peak nodal power for one or more fuel rods. For the fuel rods, a first peaking factor is developed at a first burnup threshold, a second peaking factor is developed at a second burnup threshold that is greater than first burnup threshold, and a third peaking factor is developed associated with a peak average power threshold. An adjusted peak nodal power for the fuel rods is generated in response to the base peak nodal power, the first peaking factor, the second peaking factor and the third peaking factor. The method further includes determining one or more nuclear reactor design parameters in response to the adjusted peak nodal power.

According to another aspect, a method for use in operating a nuclear reactor includes determining a base peak nodal power for one or more fuel rods. The method also includes developing for the fuel rods a first peaking factor at a first burnup threshold, a second peaking factor at a second burnup threshold that is greater than first burnup threshold, and a third peaking factor associated with a peak average power threshold. An adjusted peak nodal power is developed for the fuel rods in response to the base peak nodal power, the first peaking factor, the second peaking factor and the third peaking factor. The method further includes monitoring an operation of the nuclear reactor and evaluating the monitored operation of the nuclear reactor as a function of the adjusted peak nodal power.

According to yet another aspect a system for calculating an adjusted peak nodal power in a nuclear reactor includes a computer having a processor, a memory, and an input. The computer is configured for receiving a first burnup threshold for one or more fuel rods, a second burnup threshold for the one or more fuel rods, a peak average power threshold for the one or more fuel rods, and a base peak nodal power. The computer also includes computer executable instructions adapted for executing a method that includes developing a first peaking factor at the first burnup threshold, developing a second peaking factor at the second burnup threshold, and developing a third peaking factor associated with the peak average power threshold. The method also includes generating an adjusted peak nodal power for the fuel rods as a function of the base peak nodal power, the first peaking factor, the second peaking factor and the third peaking factor.

According to still another aspect, a system for calculating an adjusted peak nodal power in a nuclear reactor includes means for developing a first peaking factor at a first burnup threshold for one or more fuel rods. The system also includes means for developing a second peaking factor at a second burnup threshold for the fuel rods. The second burnup threshold is greater than first burnup threshold. Also included is means for developing a third peaking factor associated with a peak average power threshold for the one or more fuel rods. The system further includes means for generating an adjusted peak nodal power for the one or more fuel rods as a function of a base peak nodal power, the first peaking factor, the second peaking factor and the third peaking factor.

Further aspects of the present invention will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a flow chart of a method for determining an adjusted peak nodal power according to some exemplary embodiments.

FIG. 2 is a sectional view, with parts cut away, of a boiling water reactor for use with some exemplary embodiments.

FIG. 3 is a flow chart of a method for determining an adjusted peak nodal power through plotting of the nodal linear heat generation rate to the fuel rod nodal exposure according to one exemplary embodiment.

FIG. 4 is a graph of the base peak nodal power as nodal linear heat generation rate as a function of fuel rod nodal exposure according to another exemplary embodiment.

FIG. 5 is a graph of an adjusted peak nodal power as determined from the plot of the base peak nodal power of FIG. 4 according to one exemplary embodiment.

FIG. 6 is a block diagram of an exemplary computer system that can be used to implement some embodiments or components of the system and/or method for

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

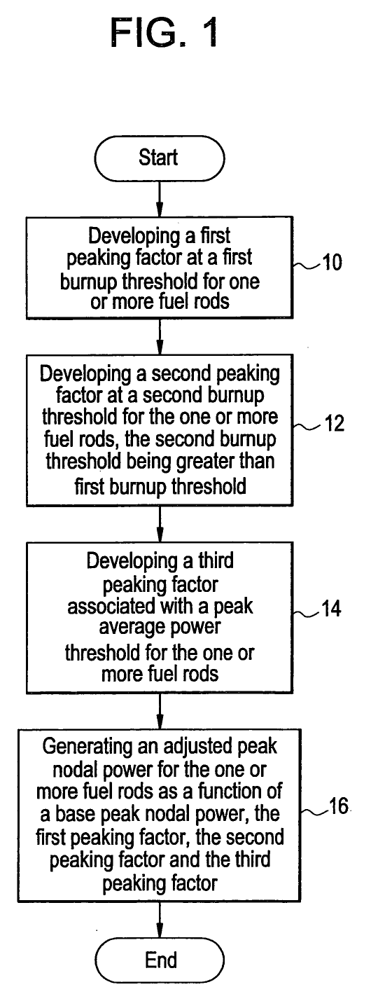

Referring to FIG. 1, exemplary embodiments of the present disclosure can provide a method for use in designing, operating and/or controlling a nuclear reactor that includes developing a first peaking factor at a first burnup threshold for one or more fuel rods as in process 10. The first burnup threshold can be any threshold suitable for operations of the reactor and can be a fuel rod nodal exposure threshold that is specified in gigawatt days per metric ton of uranium (GWD/MTU). For example, the first burnup threshold can be in the range between about forty (40) and sixty (60) GWD/MTU, and in one specific example is equal to about fifty four (54) gigawatt days per metric ton of fuel (GWD/MTU). Such a predetermined threshold value can be selected consistent with or based on a government regulation such as the above mentioned NRC AST guidelines, a nuclear plant operator's guideline as specified for operation of the reactor, a safety guideline, or a design guideline based on a design for the reactor as typically developed for a refueling operation.

A second peaking factor is developed at a second burnup threshold that is greater than the first burnup threshold as in process 12. The second burnup threshold can be a predetermined threshold as described above for the first burnup threshold and can also be a fuel rod nodal exposure threshold that is specified in GWD/MU. In some embodiments, the second burnup threshold is in the range of about sixty (60) to about eighty (80) GWD/MU, and in one exemplary embodiment, can be about sixty two (62) GWD/MU.

A third peaking factor is developed for a peak average power threshold of the fuel rods as in process 14. The peak average power threshold is typically specified in kilowatt per foot and can be in a range of about five (5.0) to about ten (10.0) kw/ft. For example, in one embodiment the peak average power threshold is equal to about six point three (6.3) kw/ft. In some embodiments, a peak nodal power threshold can be determined as a function of the peak average power threshold and a third peaking factor.

As described herein, the first, second, and/or third peaking factors are typically factors that are equal to or greater than one (1.0) and can range to any number greater than one. These peaking factors can be provided as an input or can be determined based on modeling or based on prior determinations or monitored events or parameters. For example, in some embodiments the peaking factors can be determined as a function of a fuel design of one or more of the fuel rods, a fuel design of one or more fuel assemblies, a burn-up of a fuel rod, an enrichment of a fuel rod, a gadolinium doping of a fuel rod, and an axial variation of a fuel rod, and a neutron flux emitted by a fuel rod. These peaking factors can be developed on a per plant basis, when required, as may be required to convert the rod average values of the AST limits into peak nodal rod values.

A base peak nodal power can be determined as a formula, a model, a table, or as a plot or graph, each reflecting a relationship of the nodal linear heat generation rate to the nodal burnup, which is sometimes referred to as the fuel rod nodal exposure. Burnup is generally a measure of the number of fission reactions that have occurred in a given mass of nuclear fuel. It is generally expressed as thermal energy released multiplied by the period of operation and divided by the mass of the fuel. Typical units for burnup or nodal exposure are either megawatt-days per metric ton of uranium (MWD/MTU) or gigawatt-days per metric ton of uranium (GWD/MTU).

As shown in process 16 of FIG. 1, an adjusted peak nodal power is generated, calculated or otherwise determined for the fuel rods based on or as a function of a base peak nodal power, the first peaking factor, the second peaking factor, and the third peaking factor. The base peak nodal power for the fuel rods can be previously known or based on prior input or determination, or can be determined using or from a nodal linear heat generation rate (LHGR). The LHGR is the heat balance of the reactor or fuel rod that is typically provided as an operating limit for a nuclear reactor fuel rod. One advantage of LHGR is that it can be directly calculated by core monitoring systems and can be directly compared to pre-defined operating limits. The nodal linear heat generation rate (LHGR) is typically in kilowatt per foot (kw/ft). Generally, the LHGR is nodal based for each fuel rod in a fuel assembly. A reactor can have many fuel rods (for example, 50,000 fuel rods) with each having a length of about twelve (12) feet in length and each having a diameter of about one-half of an inch. A typical fuel rod can have a plurality of nodes, such as 24 or 25 nodes, along its axial length. However, the AST limits are typically specified on rod average basis and must be converted to a nodal basis or values. By adjusting peak nodal power as described herein, the LHGR nodal values are modified to ensure compliance with the AST limited that are specified on a rod average basis.

In this manner, the adjusted peak nodal power can be utilized for a variety of nuclear reactor operational and design parameters and functions while ensuring compliance with the AST rod average limits. This can include, but is not limited to, determining a design parameter such as a fuel bundle design, determining a reactor core design, determining a rod pattern design, and determining a core flow rate. Additionally, a core monitoring system can utilize the adjusted peak nodal power for monitoring one or more nuclear reactor operations or to evaluate, such as by comparing, a monitored operation that may be identified as being related to or a function of the adjusted peak nodal power. From this, one or more operations can be adjusted. For example, by utilizing the adjusted peak nodal power, the core fluid flow rate can be adjusted in response to the evaluating of the monitored operation in view of the adjust peak nodal power.

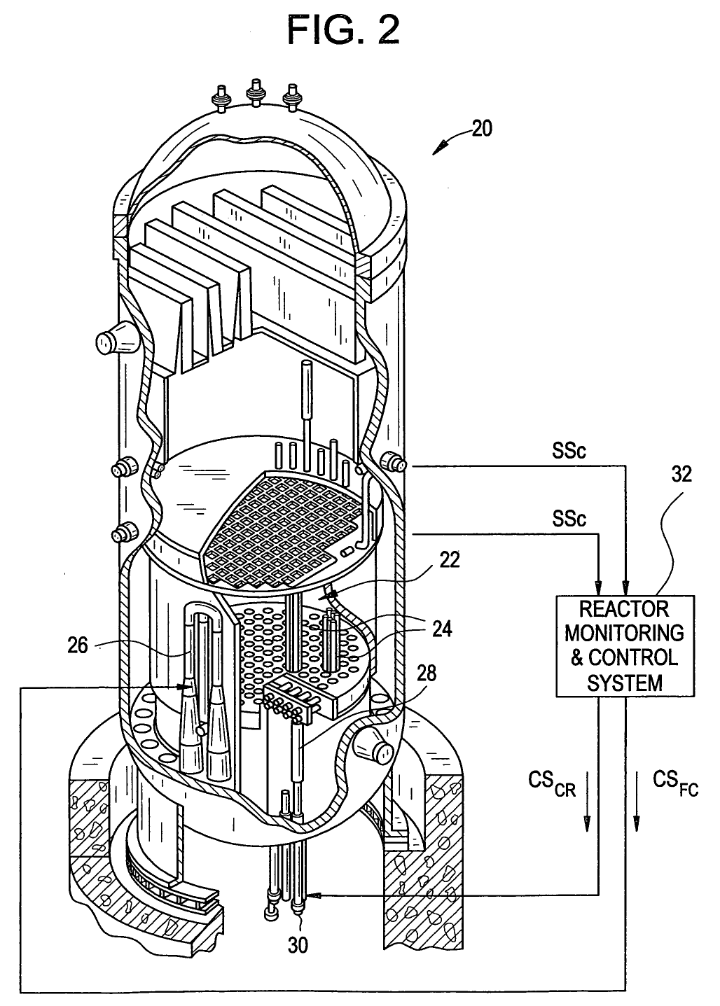

One exemplary embodiment of a nuclear reactor system associated with some exemplary methods and systems for calculating an adjusted peak nodal power is illustrated in FIG. 2. FIG. 1 is a sectional view, with parts cut away, of a boiling water nuclear reactor 20, sometime referred to as a reactor pressure vessel or RPV. Generally the illustrated components and parts are known to those skilled in the art and include various components associated with reactor control and monitoring including a reactor core 22. Heat is generated within the core 22, which includes fuel bundles 24 of fissionable material. A coolant, such as water, is circulated up through the core 22, in some embodiments via jet pumps 26 providing a controlling coolant flow through the reactor core 22. The amount of heat generated in the core 22 is regulated by inserting and withdrawing a plurality of control rods 28 of neutron absorbing material, for example, hafnium. To the extent that a control rod 28 is inserted into fuel bundle 24, it absorbs neutrons that would otherwise be available to promote the chain reaction which generates heat in core 22. The control rods 28 are controlled by a control rod drive (CRD) 30, which moves the control rod 28 relative the fuel bundles 24, thereby controlling the nuclear reaction within the core 22.

A reactor monitoring and control system 32, herein after referred to as system 32, receives a plurality of core operations sensor signals CC_{S} from core monitoring sensors (not shown) in the core 22. These monitored operations can include, but are not limited to, core reactor vessel pressure, coolant temperature, coolant flow rate, reactor power, and control rod position data. The reactor monitoring and control system 32 utilizes this input data for determining, among other characteristics, the thermal characteristics of the core, neutron escape, neutron loss, neutron generations, the actual effective k (e.g., k-eigenvalue) during each state of operation, the peak nodal power, and the adjusted peak nodal power of the core 22. The reactor monitoring and control system 32 also can generate control signals CS for controlling one or more operations or characteristics of the reactor 20. This includes control signals CS_{CR} for controlling the control rod drive 30 (and therefore the control rods 28) and control signals CS_{FR} for controlling the fluid flow rate through the core 22. The generation of nuclear energy is controlled by the reactor monitoring and control system 32, which controls the control rods 28 and the coolant flow for controlling the core 22, especially during periods of reactor operation above 25% rated power, such as when powering the reactor up and down. The reactor monitoring and control system 32 can also control these reactor operations based on pre-determined plans, which can be input into the system 32 or prepared by the system as a function of predetermined algorithms or models for a planned operation such as a control rod exchange or power up or power down condition. All power increases are done manually, so the only way flow can increase or control rods can be removed is by a manual operation. Plans are given to the operator and the operator decides if he should follow them based upon real time data from the monitoring system. The core monitoring system used to monitor AST is required to be in operation before the plant can go above 25% of rate power. In such plans, the scheduled reactor power level for each state in time and/or each exposure in the plan can be presented in a reactor power plan and related control rod control plan for the reactor operation. Other parameters, factors and correlations, including the peak nodal power and the adjusted peak nodal power can be provided to or developed by the system 32 based on one or more predefined methods implemented, at least in part, within the system 32.

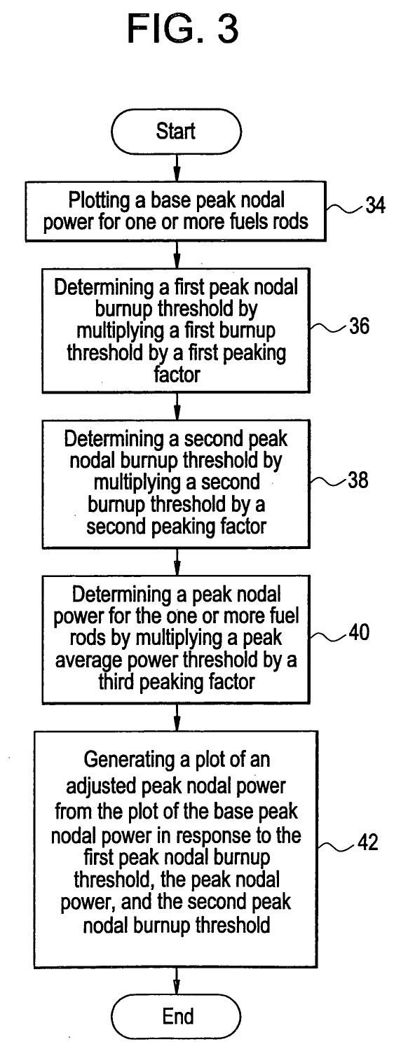

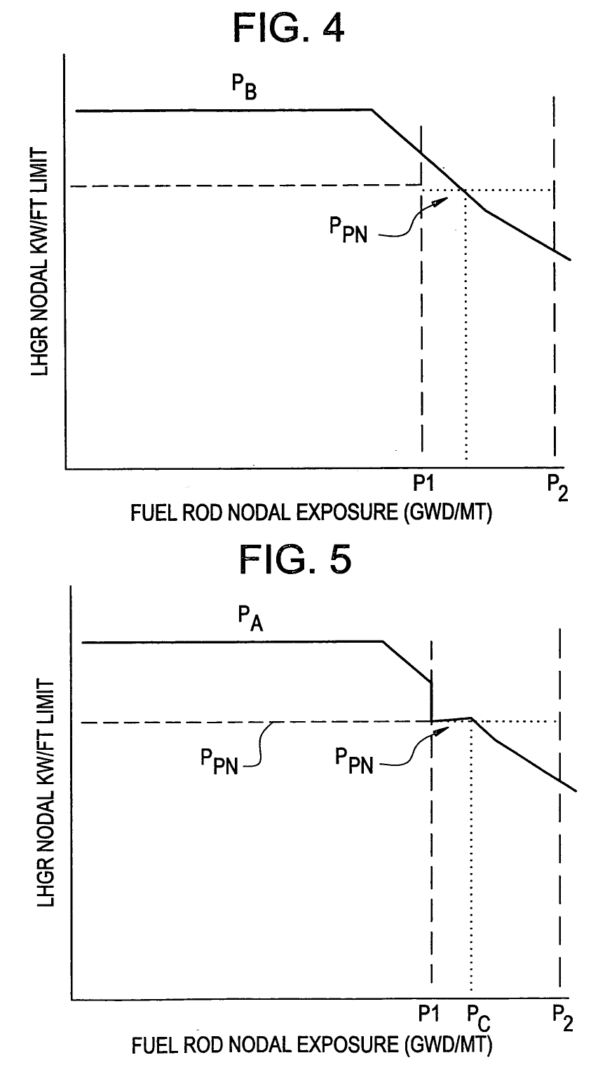

As noted above, in some exemplary embodiments, a plot of the base nodal linear heat generation rate to exposure can be adjusted or modified. For example, as described in FIG. 3, some exemplary methods include plotting a base peak nodal power for one or more fuel rods as shown in process 34 in FIG. 3. This process can be better understood by reference to the exemplary plots as shown in FIGS. 4 and 5. FIG. 4 illustrates an example of a plot of a base peak nodal power (indicated as P_{B}) as a LHGR in kw/ft to the fuel rod nodal exposure in GWD/MT.

A first peak nodal burnup threshold is determined by multiplying the first burnup threshold by the first peaking factor as in process 36. This can include identifying a first point P₁ on the base plot that defined as the product of a first burnup threshold by a first peaking factor. A second peak nodal burnup threshold is determined by multiplying the second burnup threshold by the second peaking factor as in process 38. A second point P₂ on the base plot P_{B} can be identified as the product of a second burnup threshold by a second peaking factor. Of course, as known, these plot points will shift with a change in either the value of the threshold or the value of the associated peaking factor. A peak nodal power is determined by multiplying the peak average power threshold by the third peaking factor in process 40. This is illustrated in FIG. 4 as P_{PN} and is shown as a limit or threshold on the vertical axis as LHGR.

From these determinations, the adjusted peak nodal power can be determined or generated as in process 42. The plot of FIG. 4 is adjusted as illustrated by comparison in FIG. 5. As shown, the adjusted peak nodal power P_{A} is largely based on the base peak nodal power P_{B}, but reflects an adjusted between the first plot point P₁ and the second plot point P₂.

The plot of an adjusted peak nodal power P_{A} is generated from the plot of the base peak nodal power in response to the first peak nodal burnup threshold, the peak nodal power, and the second peak nodal burnup threshold. As shown in FIG. 5, the plot of the nodal linear heat generation rate between the first plot point P₁ and the second plot point P₂ is reduced, where the LHGR of the base P_{B} is greater than the determined peak nodal power P_{PN}. As illustrated in FIG. 5, the base P_{B} is greater than the determined peak nodal power P_{PN} from first plot point P1 to a cutoff point P_{C}. The cutoff point P_{C} is the point on the base PB plot where the LHGR reduces to a value that is equal to or less than the determined peak nodal power P_{PN}. After the cutoff point P_{C}, the adjusted peak nodal power again become equivalent to the base P_{B} plot. The reduction of the adjusted peak nodal power or LHGR at the first plot point P₁ to be below the determined peak nodal power P_{PN} ensures compliance with a preferred guideline as the AST. As illustrated in FIG. 5, the reduction to the base P_{B} only occurs where the LHGR is greater than the determined peak nodal power P_{PN}. As such, the cutoff point P_{C} only identifies the fuel rod nodal exposure value at which the LHGR become equal to or less than the determined peak nodal power P_{PN}.

In some embodiments, a system, such as the exemplary system 32 of FIG. 2, can be utilized for calculating an adjusted peak nodal power in a nuclear reactor that includes a computer operating environment such as a computer having a processor, a memory, and an input. The computer is configured for receiving a first burnup threshold for one or more fuel rods, a second burnup threshold for the one or more fuel rods, a peak average power threshold for the one or more fuel rods, and a base peak nodal power. The computer also includes computer executable instructions adapted for executing one or more of the exemplary methods and/or processes as described above. For example, the computer executable instructions can be adapted for performing and/or otherwise enabling the processing of a method that includes developing a first peaking factor at the first burnup threshold, developing a second peaking factor at the second burnup threshold, and developing a third peaking factor associated with the peak average power threshold. The method also includes generating an adjusted peak nodal power for the fuel rods as a function of the base peak nodal power, the first peaking factor, the second peaking factor and the third peaking factor. Of course other computer executable instructions can be developed and implemented for performing one or more of the other processes as described herein.

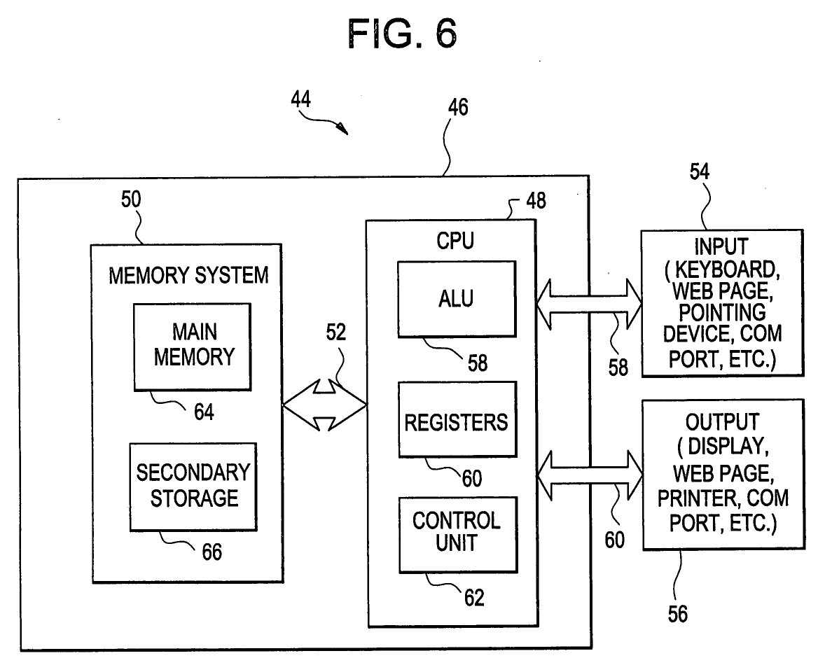

One exemplary computer operating environment for one or more embodiments for calculating, determining, and/or generating an adjusted peak nodal power for designing and operating a nuclear reactor is illustrated in FIG. 6, by way of example. Additionally, various embodiments as described herein can be advantageously applied to environments requiring management and/or optimization of any multiple control-variable critical industrial/scientific process or system, including chemical and mechanical process simulation systems, pressurized water reactor simulation systems, boiling water reactor simulation systems, and the like. As one exemplary embodiment of such an operating environment for a reactor core monitoring, planning, and/or prediction system can include a system 44 with a computer 46 that includes at least one high speed processing unit (CPU) 48, in conjunction with a memory system 50 interconnected with at least one bus structure 52, an input 54, and an output 56.

The input 54 and output 56 are familiar and can be compliant and interoperable with local and remote user interfaces as well as a controller, remote operational system and operations system, by way of example. The input 54 can include a keyboard, a mouse, a physical transducer (e.g. a microphone), or communication interface or port, by way of example, and is interconnected to the computer 46 via an input interface 58. The output 56 can includes a display, a printer, a transducer (e.g. a speaker), output communication interface or port, etc, and be interconnected to the computer 46 via an output interface 60. Some devices, such as a network adapter or a modem, can be used as input and/or output devices.

The illustrated CPU 48 is of familiar design and includes an arithmetic logic unit (ALU) 58 for performing computations, a collection of registers 61 for temporary storage of data and instructions, and a control unit 62 for controlling operation of the system 44. Any of a variety of processors, including at least those from Digital Equipment, Sun, MIPS, Motorola/Freescale, NEC, Intel, Cyrix, AMD, HP, and Nexgen, is equally preferred for the CPU 58. The illustrated embodiment of the disclosure operates on an operating system designed to be portable to any of these processing platforms.

The memory system 50 generally includes high-speed main memory 64 in the form of a medium such as random access memory (RAM) and read only memory (ROM) semiconductor devices, and secondary storage 66 in the form of long term storage mediums such as floppy disks, hard disks, tape, CD-ROM, flash memory, etc. and other devices that store data using electrical, magnetic, optical or other recording media. The main memory 64 also can include a video display memory for displaying images through a display device. Those skilled in the art will recognize that the memory system 50 can comprise a variety of alternative components having a variety of storage capacities.

As is familiar to those skilled in the art, the system 44 can further include an operating system and at least one application program (not shown). The operating system is the set of software which controls the computer system's operation and the allocation of resources. The application program is the set of software that performs a task desired by the user, using computer resources made available through the operating system. Both are resident in the illustrated memory system 50. As known to those skilled in the art, some of the methods, processes, and/or functions described herein can be implemented as software and stored on various types of computer readable medium as computer executable instructions. In various embodiments of the methods described by example herein, the computer system can include a robust operating and application program having the computer executable instructions for performing one or more of the above processes. Additionally, one or more of the local and remote user interfaces, operations system and remote operations system can include, among other application software programs with computer executable instructions, a thin client application for communicating and interactively operating with one or more controllers as described above by way of example.

In accordance with the practices of persons skilled in the art of computer programming, the present disclosure is described below with reference to symbolic representations of operations that are performed by the system 44. Such operations are sometimes referred to as being computer-executed. It will be appreciated that the operations which are symbolically represented include the manipulation by the CPU 48 of electrical signals representing data bits and the maintenance of data bits at memory locations in the memory system 50, as well as other processing of signals. The memory locations where data bits are maintained are physical locations that have particular electrical, magnetic, or optical properties corresponding to the data bits. The disclosure can be implemented in a program or programs, comprising a series of instructions stored on a computer-readable medium. The computer-readable medium can be any of the devices, or a combination of the devices, described above in connection with the memory system 50.

It should be understood to those skilled in the art, that some embodiments of systems or components for calculating the adjusted peak nodal power, as described herein, can have more or fewer computer processing system components and still be within the scope of the present disclosure.

As described herein, the inventors hereof have determined that the LHGR limits can be correlated to the AST limits, and as such, the LHGR limits can be adjusted to ensure compliance with the AST rod average power limits as specified by the NRC. Additionally, the LHGR limits can be adjusted to ensure that they are more restricted than the AST limits. As the LHGR limits are also used in the core design process, the adjusted LHGR limits ensure compliance with the AST limits. This adjustment also includes ensures compliance of in-monitoring plans, software changes, and design process changes. Therefore one or more embodiments of the present disclosure can provide for adjusted peak nodal powers for nuclear reactors that are capable of enabling improvements in fuel rod and core design, improved reactor monitoring, e.g., monitoring limits that have been adjusted to correlate to regulatory defined AST limits, and improved reactor operations while ensuring compliance with objectives and guidelines. Such improvements can provide for reduced refueling outages, increases in safety margins, and improved plant operating margins.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A method for a nuclear reactor comprising:
developing a first peaking factor at a first burnup threshold for one or more fuel rods;
developing a second peaking factor at a second burnup threshold for the one or more fuel rods, the second burnup threshold being greater than first burnup threshold;
developing a third peaking factor associated with a peak average power threshold for the one or more fuel rods; and
generating an adjusted peak nodal power for the one or more fuel rods as a function of a base peak nodal power, the first peaking factor, the second peaking factor and the third peaking factor.

2. The method of claim 1, further comprising determining the base peak nodal power for the one or more fuel rods.

3. The method of claim 2 wherein determining the base peak nodal power for the one or more fuel rods includes determining a nodal linear heat generation rate in kw/ft.

4. The method of claim 3, further comprising plotting the base peak nodal power as the nodal linear heat generation rate as a function of nodal burnup.

5. The method of claim 4 wherein generating the adjusted peak nodal power includes adjusting the plot of the base peak nodal power to determine a plot of the adjusted peak nodal power by reducing the nodal linear heat generation rate of the base plot to a level equal to or less than the peak average power threshold multiplied by the third peaking factor, the reducing occurring at a nodal burnup equal to or greater than the first burnup threshold multiplied by the first peaking factor.

6. The method of claim 5 wherein the reducing is eliminated where the base plot has a nodal burnup greater than the second burnup threshold multiplied by the second peaking factor.

7. The method of claim 1, further comprising generating a peak nodal power threshold as a function of the peak average power threshold and third peaking factor.

8. The method of claim 1 wherein the first burnup threshold is equal to about 54 gigawatt days per metric ton of fuel (GWD/MU).

9. The method of claim 1 wherein the second burnup threshold is equal to about 62 gigawatt days per metric ton of fuel (GWD/MU).

10. The method of claim 1 wherein the peak average power threshold is equal to about 6.3 kw/ft.

11. The method of claim 1 wherein the first and second burnup thresholds are fuel rod nodal exposure thresholds.

12. The method of claim 1 wherein developing the first, second, and third peaking factors are each a function of one or more of the factors selected from the group consisting of a fuel design of a fuel rod, a fuel design of a fuel assembly, a burn-up of a fuel rod, an enrichment of a fuel rod, a gadolinium doping of a fuel rod, and an axial variation of a fuel rod, and a neutron flux emitted by a fuel rod.

13. The method of claim 1 wherein each of the first, second, and third peaking factors are equal to or greater than 1.0.

14. The method of claim 13 wherein the first, second and third burnup thresholds are established as a function of a predetermined threshold value selected from the group consisting of a government regulation, an operator guideline, a safety guideline, and a design guideline.

15. The method of claim 1 wherein generating the adjusted peak nodal power includes:
determining a first peak nodal burnup threshold by multiplying the first burnup threshold by the first peaking factor;
determining a second peak nodal burnup threshold by multiplying the second burnup threshold by the second peaking factor;
determining a peak nodal power of the one or more fuel rods by multiplying the peak average power threshold by the third peaking factor; and
modifying the base peak nodal power to include the first peak nodal burnup threshold, the peak nodal power, and the second peak nodal burnup threshold.

16. The method of claim 16 wherein the base peak nodal power includes a nodal linear heat generation rate having a predetermined relationship to the nodal burnup and wherein modifying the base peak nodal power includes modifying the nodal linear heat generation rate predetermined relationship by reducing the nodal linear heat generation rate to the peak nodal power at nodal burnups equal to or greater than the first peak nodal burnup threshold and less than the second peak nodal burnup threshold.

17. The method of claim 16 wherein the average base peak nodal power and the adjusted peak nodal power are each represented by at least one of a graphical curve and a mathematical formula.

18. The method of claim 17, further comprising utilizing the adjusted peak nodal power for a process selected from the group consisting of determining a fuel bundle design, determining a reactor core design, determining a rod pattern design, and determining a core flow rate.

19. The method of claim 17, further comprising:
monitoring an operation of the nuclear reactor;
evaluating the monitored operation of the nuclear reactor as a function of the adjusted peak nodal power; and
adjusting a core fluid flow rate in response to the evaluating of the monitored operation.

20. A method for a nuclear reactor comprising:
determining a base peak nodal power for one or more fuel rods;
developing for the one or more fuel rods a first peaking factor at a first burnup threshold, a second peaking factor at a second burnup threshold, and a third peaking factor associated with a peak average power threshold;
determining a first peak nodal burnup threshold by multiplying the first burnup threshold by the first peaking factor;
determining a second peak nodal burnup threshold by multiplying the second burnup threshold by the second peaking factor;
determining a peak nodal power for the one or more fuel rods by multiplying the peak average power threshold by the third peaking factor; and
generating an adjusted peak nodal power for the one or more fuel rods in response to the base peak nodal power, the first peak nodal burnup threshold, the peak nodal power and the second peak nodal burnup threshold.

21. The method of claim 20 wherein generating the adjusted peak nodal power includes:
plotting the base peak nodal power as nodal linear heat generation rate as a function of nodal burnup in gigawatt days per metric ton of fuel; and
adjusting the plot of the base peak nodal power to determine a plot of the adjusted peak nodal power by reducing the nodal linear heat generation rate of the base plot to a level equal to or less than the peak average power threshold multiplied by the third peaking factor, wherein the reducing occurs at a nodal burnup equal to or greater than the first burnup threshold multiplied by the first peaking factor and at a nodal burnup less than the second burnup threshold multiplied by the second peaking factor.

22. The method of claim 20, further comprising utilizing the plot of the adjusted peak nodal power for a process selected from the group consisting of determining a fuel bundle design, determining a reactor core design, determining a rod pattern design, and determining a core flow rate.

23. The method of claim 20, further comprising:
monitoring an operation of the nuclear reactor;
comparing the monitored operation against the plot of the adjusted peak nodal power; and
adjusting a core fluid flow rate in response to the evaluating of the monitored operation.

24. A method for a nuclear reactor comprising:
plotting a base peak nodal power for one or more fuel rods;
determining a first peak nodal burnup threshold by multiplying a first burnup threshold by a first peaking factor;
determining a second peak nodal burnup threshold by multiplying a second burnup threshold by a second peaking factor;
determining a peak nodal power for the one or more fuel rods by multiplying a peak average power threshold by a third peaking factor; and
generating a plot of an adjusted peak nodal power from the plot of the base peak nodal power in response to the first peak nodal burnup threshold, the peak nodal power, and the second peak nodal burnup threshold.

25. The method of claim 24 wherein
plotting a base peak nodal power includes plotting a nodal linear heat generation rate as a function of nodal burnup, and
generating the adjusted peak nodal power includes adjusting the plot of the base peak nodal power by reducing the nodal linear heat generation rate to a level equal to or less than the peak nodal power, wherein the reducing occurs at a nodal burnup equal to or greater the first peak nodal burnup threshold and at a nodal burnup less than the second peak nodal burnup threshold.

26. A method for use in designing a nuclear reactor comprising:
determining a base peak nodal power for one or more fuel rods;
developing for the one or more fuel rods a first peaking factor at a first burnup threshold, a second peaking factor at a second burnup threshold that is greater than first burnup threshold, and a third peaking factor associated with a peak average power threshold;
generating an adjusted peak nodal power for the one or more fuel rods in response to the base peak nodal power, the first peaking factor, the second peaking factor and the third peaking factor; and
determining one or more nuclear reactor design parameters in response to the adjusted peak nodal power.

27. The method of claim 26 wherein the one or more design parameters are selected from the group consisting of a fuel bundle design, a reactor core design, a rod pattern design and a core flow rate.

28. The method of claim 26 wherein generating the adjusted peak nodal power includes:
plotting the base peak nodal power as nodal linear heat generation rate as a function of nodal burnup in gigawatt days per metric ton of fuel; and
adjusting the plot of the base peak nodal power to determine a plot of the adjusted peak nodal power by reducing the nodal linear heat generation rate of the base plot to a level equal to or less than the peak average power threshold multiplied by the third peaking factor, wherein the reducing occurs at a nodal burnup equal to or greater than the first burnup threshold multiplied by the first peaking factor and at a nodal burnup less than the second burnup threshold multiplied by the second peaking factor.

29. A method for use in operating a nuclear reactor comprising:
determining a base peak nodal power for one or more fuel rods;
developing for the one or more fuel rods a first peaking factor at a first burnup threshold, a second peaking factor at a second burnup threshold that is greater than first burnup threshold, and a third peaking factor associated with a peak average power threshold;
generating an adjusted peak nodal power for the one or more fuel rods in response to the base peak nodal power, the first peaking factor, the second peaking factor and the third peaking factor;
monitoring an operation of the nuclear reactor; and
evaluating the monitored operation of the nuclear reactor as a function of the adjusted peak nodal power.

30. The method of claim 29 wherein generating the adjusted peak nodal power includes:
plotting the base peak nodal power as nodal linear heat generation rate as a function of nodal burnup in gigawatt days per metric ton of fuel; and
adjusting the plot of the base peak nodal power to determine a plot of the adjusted peak nodal power by reducing the nodal linear heat generation rate of the base plot to a level equal to or less than the peak average power threshold multiplied by the third peaking factor, wherein the reducing occurs at a nodal burnup equal to or greater than the first burnup threshold multiplied by the first peaking factor and at a nodal burnup less than the second burnup threshold multiplied by the second peaking factor.

31. The method of claim 29, further comprising adjusting a core fluid flow rate in response to the evaluating of the monitored operation.

32. The method of claim 29 wherein evaluating includes comparing the monitored operation to a regulatory defined standard for an Alternative Source Term (AST).

33. A system for calculating an adjusted peak nodal power in a nuclear reactor comprising a computer having a processor, a memory, and an input configured for receiving a first burnup threshold for one or more fuel rods, a second burnup threshold for the one or more fuel rods, a peak average power threshold for the one or more fuel rods, and a base peak nodal power, the computer also including computer executable instructions adapted for executing the method including developing a first peaking factor at the first burnup threshold, developing a second peaking factor at the second burnup threshold, developing a third peaking factor associated with the peak average power threshold, and generating an adjusted peak nodal power for the one or more fuel rods as a function of the base peak nodal power, the first peaking factor, the second peaking factor and the third peaking factor.

34. A system for calculating a adjusted peak nodal power in a nuclear reactor comprising:
means for developing a first peaking factor at a first burnup threshold for one or more fuel rods;
means for developing a second peaking factor at a second burnup threshold for the one or more fuel rods, the second burnup threshold being greater than first burnup threshold;
means for developing a third peaking factor associated with a peak average power threshold for the one or more fuel rods; and
means for generating an adjusted peak nodal power for the one or more fuel rods as a function of a base peak nodal power, the first peaking factor, the second peaking factor and the third peaking factor.
